(19) United States
(12) Patent Application Publication
(10) Pub. No.: US 2005/0181097 A1
(43) Pub. Date: Aug. 18, 2005

(54) Nutritionally complete pet food and method of feeding and manufacturing same

(75) Inventors: Stewart Townsend, Yorba Linda, CA (US); Kristin Boyle, Marina Del Ray, CA (US); Dan Beyer, Vernon, CA (US); Oscar Ortiz, Hawthorne, CA (US); Allan A. Torney, Bolton (CA); Frank Shields, La Verne, CA (US); Helen Munday, Melton Mowbray (GB); Alexandre C. Mendes, Redondo Beach, CA (US); Angel Hernandez, Chino, CA (US); Emine Unlu, Pasadena, CA (US); Saeed Ahmed, Norwalk, CA (US); Peter S. Slusarczyk, Fergus (CA); Christopher Frank, Oakdale, CA (US); Liisa Mooney, Toronto (CA); Kasim A. Zubair, Brampton (CA); Tiffany L. Bierer, Vernon, CA (US)

Correspondence Address: FULBRIGHT & JAWORSKI, LLP, 1301 MCKINNEY, SUITE 5100, HOUSTON, TX, 77010-3095, US

(73) Assignee: MARS, INC., McLean, VA (US)

(21) Appl. No.: 11/051,743

(22) Filed: Feb. 4, 2005

Related U.S. Application Data
(63) Continuation-in-part of application No. 10/789,538, filed on Feb. 27, 2004.
Application No. 10/789,538 is a continuation-in-part of application No. 10/244,259, filed on Sep. 16, 2002, now Pat. No. 6,896,924.

(51) Int. Cl. A23G 1/00

(52) U.S. Cl. 426/89

(57) ABSTRACT

The present invention is directed to a nutritionally complete and preferably balanced, shelf stable pet food product, a method of feeding the pet food product to an animal and a process of manufacturing that pet food product. The method of feeding an animal includes the step of feeding a preferred pet food product to the animal, wherein the pet food product is a nutritionally complete meal and is configured such that the animal can hold the product with its appendages while eating the product.

### CROSS REFERENCE TO RELATED APPLICATIONS

This application is a continuation-in-part of U.S. application Ser. No. 10/789,538 filed Feb. 27, 2004 which is a continuation-in-part of U.S. Ser. No. 10/244,259 filed on Sep. 16, 2002, both which are incorporated herein.

### TECHNICAL FIELD

The present invention is directed to a pet food product and more particularly to a nutritionally complete and preferably balanced, shelf stable pet food product, a method of feeding the pet food product to an animal and a process of manufacturing that pet food product.

### BACKGROUND OF THE INVENTION

It has long been known that dry, crunchy pet foods have desirable teeth cleaning and storage characteristics, such as the dry kibble pet food products that are commonly known. It has long been known that soft, meaty pet foods are very palatable to companion animals and these types of food have many advantages to pet owners. There are numerous kinds of both of these pet foods available as complete meals and as treats and snacks.

One example of a semi-moist pet food described as a complete meal is Purina's Butcher's Burger—chopped Burger. An example of a dry kibble pet food providing a complete meal is Hill's® Prescription Diet Canine t/d® and Canine t/d® Small Bites. Examples of two component treats and snacks include Pet Pride DogGone Deli Bone Style Crunchy Treats and Sausage Style Snacks, Purina Dogwiches Dog Treat and Busy Bones, Milk-Bone Dog Treats with Bone Marrow, Del Monte Chew Lotta, and Pedigree Jumbone®. One component treats include Pet Pride Dental Chew Bone and Pedigree Dentabone®.

Blends of pet foods having a hard outer component and a soft textured inner component have been extensively produced and have achieved notable success. Examples of such pet foods are described in U.S. Pat. Nos. 3,916,029, 4,777,058 and 6,117,477. Other pet foods having a soft-textured outer component and a hard inner component are described in U.S. Pat. Nos. 4,900,572 and 4,260,635. U.S. Pat. No. 4,032,665 describes a simulated bone for use as a treat for pets. U.S. Pat. No. 4,900,572 discloses a dual textured pet food generally in the shape of a marrow bone and the method for manufacturing the dual-textured pet food.

U.S. Pat. No. 5,431,927 describes a pet food kibble having an expanded striated structural matrix that fractures when chewed by a pet. U.S. patent application publications U.S. Pub. Nos. 2002/0090444 A1; 2002/0150650 A1 and 2003/0021872 A1 describe a pet food kibble that is less brittle and has a density of less than 20.5 lbs/ft³.

The present invention provides a novel pet food product in which a small number of pieces of the product provide a nutritionally complete and preferably balanced meal for an animal. The present invention also provides a new method of feeding a complete and balanced meal to an animal. The present invention is further of a cohesive nature that results in a pet food that is not messy to feed and further provides eating enjoyment to an animal.

### BRIEF SUMMARY OF THE INVENTION

The present invention is directed to a pet food product comprising N pieces wherein N pieces provide the complete daily nutritional requirements of an animal, and N equals 1 to 15 pieces. N pieces also provide the complete and balanced daily nutritional requirements of an animal. Each of the N pieces has a toughness in the range of 0.5 to 5.5 W, a brittleness in the range of 430 to 1160 mm; a hardness in the range of 70 to 520 N, an outer component hardness in the range of 50 to 1000 N, preferably 50 to 300N, and an inner component hardness of 50 to 2760 of N, and a density in the range of 0.6 to 1.7 g/cm³.

N can be less than 10 pieces or 2 to 6 pieces and an N piece(s) has a consumption time of two to sixty minutes.

Each of the N pieces of the inventive pet food product has about 2.80 kcals per gram and a caloric density per unit volume of about 1.8 to 11.1 kcal/cm³, and preferably about 3.70 kcal/cm³. Each of the N pieces has a caloric content of about 30 to 2500 kcal per piece and preferably between 50 to 2500 kcal per piece.

Each piece of the inventive pet food product can be comprised of two components, an outer component and an inner component, wherein the inner and outer component have a different quality selected from the group consisting of hardness, brittleness, toughness, density, caloric density, calories per gram, color and flavor. The ratio of the two components (inner/outer ratio) can be about 0:100 to 100:0, with a preferred range of 90:10 to 10:90, with a more preferred range of 80:20 to 20:80, and a most preferred range of 70:30 to 30:70. The outer component can have a higher value of at least one value selected from the group consisting of hardness, brittleness, toughness, and density. Further, the color and/or flavor of the outer component can be different than the color and/or flavor of the inner component. The inner component can have a higher value of at least one value selected from the group consisting of hardness, brittleness, toughness, and density. Alternatively, the pet food product can be a single component.

The inventive pet food product has a protein content greater than 15 wt %, a preferred range of 15 to 65 wt %, a more preferred range of 15 to 35 wt %, and a most preferred range of 18 to 25 wt %. The carbohydrate content is in the range of 30 to 70 wt %, preferably 35 to 50 wt % and most preferable 40 to 45 wt %. The fat content is greater than 3 wt %, in a preferred range of 3 to 20.0 wt %, a more preferred range of 3 to 10.0 wt % and a most preferred range of 3.0 to 8.0 wt %. The crude fiber content is in the range of 0 to 10 wt %, a preferred range of 0.5 to 9 wt %, a more preferred range of 1.0 to 8 wt %, and a most preferred range of 2.0 to 8.0 wt %. The pet food product has a percent moisture of 6 to 32%, a preferred range of 12 to 28%, a more preferred range of 14 to 24%, and a most preferred range of 14 to 22%. The water activity (Aw) is less than 0.9, in preferred range of 0.5 to 0.90, a more preferred range of 0.6 to 0.85, and a most preferred range of 0.65 to 0.80. Each piece of the inventive pet food product is cohesive.

The inventive pet food product can have a longitudinal shape and a cross sectional shape in the form of a modified triangle. The pet food can have a length greater than 5 cm. and a cross sectional area in the range of 3.0 to 18.0 cm². Preferably, pet food product can have a length in the range of 5 to 25 cm, a width in the range of 2.5 to 17.5 cm, and a depth in the range of 0.42 to 5.0 cm. The pet food product has a weight in the range of 15 to 400 grams.

The present invention is directed to a method of feeding an animal comprising the step of feeding a preferred pet food product to the animal, wherein the pet food product is a nutritionally complete meal and is configured such that the animal can hold the product with its appendages while eating the product. The pet food product is preferred by 60% of dogs over a standard dry kibble pet food and the pet food product comprises a nutritionally complete meal having a ‘well-being’ score of at least 3.2.

The present invention is directed to a feeding system for dogs comprising the steps of providing a pet food product in a plurality of sizes wherein each size of the product has a different caloric content; feeding a dog N pieces of the pet food product selected from the plurality of sizes; wherein N equals 1 to 15 in which N pieces provide the complete and balanced daily nutritional requirements of the dog, and each piece has a caloric content of 50 to 2500 kcals. In the feeding system, N is dependent upon factors selected from a group consisting of an animal's weight, size, breed, lifestage, activity level, body condition, health condition and total daily energy requirements.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a graph illustrating the average daily caloric requirements of a dog vs the dog's weight;

FIG. 2 is a cross sectional view of a skull of a dog;

FIG. 3 is a cross sectional view of a preferred embodiment of the present invention;

FIG. 4 is a perspective view of a preferred embodiment of the present invention;

FIG. 5 is a perspective view of another preferred embodiment of the present invention;

FIG. 6 is a perspective view of another preferred embodiment of the present invention;

FIG. 7 is a perspective view of yet another preferred embodiment of the present invention;

FIG. 8 is a flow diagram of a method of manufacturing the present invention;

FIG. 9 is a perspective illustration of a sample used in a compression test;

FIG. 10 is a perspective illustration of a sample used in a triple point bend test;

FIG. 11 is an illustration of a bend texture analysis graph; and

FIG. 12 is an illustration of a puncture texture analysis graph.

### DETAILED DESCRIPTION OF THE INVENTION

As used herein, the use of the word “a” or “an” when used in conjunction with the term “comprising” in the claims and/or the specification may mean “one,” but it is also consistent with the meaning of “one or more,” “at least one,” and “one or more than one.”

Water activity is a measurement of the energy status of the water in a system; represented by a quotient between water's partial pressure in the food and pure water's partial pressure. It indicates how tightly water is bound, structurally or chemically, within a substance. This is measured by equilibrating the liquid phase (in the sample) with the vapor phase (in the headspace) and measuring the relative humidity of that space. Moisture is a quantitative analysis to determine the total amount of water present in a sample.

The present invention is directed to a nutritionally complete and preferably balanced pet food product.

A complete food is a nutritionally adequate feed for animals other than man, that can be fed as a sole ration and is capable of sustaining life without additional food (aside from water).

Balanced food is a complete feed also having all known nutrients in the proper amount and proportion

As used herein, animal is defined as a non-human animal, preferably a companion animal, and most preferably, dogs, cats and horses.

The present invention provides a new method of feeding a complete and balanced meal to an animal, which also provides for increased interaction between the animal and the product, resulting in a more fun and enjoyable feeding experience for the animal. This improved feeding experience is demonstrated in product design tests that showed increased scores over dry kibble for well-being, occupation and/or satisfaction, convenience and/or mess and texture preferences. The improved feeding experience and increased well being of the animal are a result of the inventive product's design features, such as size, lasting time and nutritional content. The inventive pet food product's composition and textural properties are specifically formulated to provide a pet food that has a specific caloric content that meets the nutritional requirements for an animal within the product's recommended serving size, that will provide a satisfying and satiating meal for the animal and will provide a serving size that the animal can consume in a reasonable amount of time within a day.

The inventive product of the present invention provides a novel method of feeding an animal wherein the animal receives it's entire required caloric and nutrient intake in one to fifteen pieces, less than ten pieces, and preferably two to six pieces.

The inventive product of the present invention also provides a novel feeding system for an animal wherein the animal entire required caloric and nutrient intake is based upon the animal's weight, size, breed, lifestage, activity level, body condition, health condition or total daily energy requirements.

The method of feeding the inventive pet food product is different from feeding an animal wet or dry pet food products in that the inventive pet food is generally not fed in a bowl. Because of the way in which the inventive product is fed, it changes the way in which the animal eats the food, generally making it a better experience for both the owner and the animal. This is because the shape of the inventive product forces the dog to chew the product in order to consume it and because of this chewing process, dogs will consume all or most of the inventive product in one sitting, which adds to the benefit of eating enjoyment for the dog. The length of the inventive product is also a benefit to a dog's eating enjoyment as it allows the dog to be able to hold the inventive food product with its paws or appendages while eating it. This overall change in product design and the method of feeding the animal has shown unexpectedly high consumer scores for a nutritionally complete pet food product.

An object of this invention is a complete meal which also improves the well-being of the animal by improving the overall eating experience for both the owner and the animal. The inventive product provides increased interaction between the animal and the product making the experience more fun and enjoyable for the animal. Preferably the product provides for a longer eating time and more satisfying chewing experience for the animal. The most preferred product is also less messy and more convenient to feed.

The attributes described above are measured using the following two phase product design test.

Two Phase Product Design Test

At least 1000 respondents are selected from group consisting of dog owners, over the age of eighteen and in a ratio of eighty percent female and twenty percent male.

The first phase is exposing respondents to and evaluation of a written concept described as a total approach to the health of a dog that included a unique bone shape that provided dental care and calcium, the balanced nutrition of a whole meal, and a bone-shaped product that a dog can hold with its paws and enjoy the chewing satisfaction that is linked to a dog's level of contentment.

Respondents are exposed to the product concept and subsequently taken through an evaluative questionnaire. The questionnaire asked questions relating to how the respondent feels about his/her dog; the size and breed of the dog and number of dogs in the household; where dog food was purchased; based on the proposed product, would the respondent purchase the new product; what the respondent liked or disliked about the product; was the product new and different from other products currently available; how much of the product the respondent would expect his/her dog to eat; would the product be appropriate for a meal; where would the product be fed to the dog; what kinds of pet food or treats were currently being given to respondent's dog; the age of the respondent; and the gender of the respondent.

Respondents expressing positive or neutral concept purchase interest are selected for the next phase of the product design testing. Purchase interest in the concept is determined in the following way: respondents are asked to respond to the following question; “How interested would you be to purchase the Product?” Participants respond on the following five point scale: 5—Definitely Would Buy; 4—Probably Would Buy; 3—May or May Not Buy; 2—Probably Would Not Buy; and 1—Definitely Would Not Buy. Those respondents that respond with a score of 5, 4 or 3 are selected as being positive or neutral to the concept.

Only respondents who respond favorably or neutral to the written concept move on to the next phase of the test which involves actual product usage. After approximately one week of in-home usage, these participants are contacted again to complete an after use questionnaire on their experience with the product.

The questionnaire asks them to respond to a series of statements related to seven specific attributes of the product: uniqueness, mess, well-being, occupation, convenience, satisfaction and texture. The respondents answer using the 5 point scale below indicating how they agree with the statement. The average of the respondents'scores are taken as the attribute score for the test product. A sample of some of the attributes, questions, scoring scale and how the attribute scores are determined is illustrated below.

| | Question - How much do you agree with the | | Attribute |
|---|---|---|---|
| Attribute | following statements? | Scoring Scale | Score |
| Uniqueness | 1) Is a revolutionary way to serve your dog | (Strongly disagree) 0 | Avg. of |
| | meals. | to | responses to |
| | | 5 (Strongly agree) | question 1) |
| Mess | 2) Is not messy. | (Strongly disagree) 0 | Avg. of |
| | | to | responses to |
| | | 5 (Strongly agree) | question 2) |
| Well-being | 3) Provides a fun and enjoyable experience | (Strongly disagree) 0 | Avg. of |
| | for your dog. | to | responses to |
| | | 5 (Strongly agree) | question 3 and |
| | | | 4) |
| | 4) Is a food that will improve your dog's | (Strongly disagree) 0 | |
| | well-being. | to | |
| | | 5 (Strongly agree) | |
| Occupation | 5) Keeps your dog occupied for a longer | (Strongly disagree) 0 | Avg. of |
| | time. | to | responses to |
| | | 5 (Strongly agree) | question 5) |
| Convenience | 6) Is appropriate for everyday use | (Strongly disagree) 0 | Avg. of |
| | | to | responses to |
| | | 5 (Strongly agree) | question 6) and |
| | | | 7) |
| | 7) Makes feeding the right amount easy | (Strongly disagree) 0 | |
| | | to | |
| | | 5 (Strongly agree) | |
| Chewing | 8) Satisfies your dog's need for chewing. | (Strongly disagree) 0 | Avg. of |
| Satisfaction | | to | responses to |
| | | 5 (Strongly agree) | question 8) |
| Texture | 9) Has a texture your dog would like. | (Strongly disagree) 0 | Avg. of |
| | | to | responses to |
| | | 5 (Strongly agree) | question 9) |

The product of this invention has an average Well-being score of at least 3, preferably at least 3.2, more preferably at least 3.4, more preferably at least 3.6, more preferably at least 3.8, more preferably at least 4.0, more preferably at least 4.2 and most preferably at least 4.4. A more preferred embodiment of the invention also has a score at least 3, preferably at least 3.2, more preferably at least 3.4, more preferably at least 3.6, more preferably at least 3.8, more preferably at least 4.0, more preferably at least 4.2 and most preferably at least 4.4 for Occupation and/or Chewing Satisfaction. An more preferred embodiment additionally has a Convenience and/or Mess score at least 3, preferably at least 3.2, more preferably at least 3.4, more preferably at least 3.6, more preferably at least 3.8, more preferably at least 4.0, more preferably at least 4.2 and most preferably at least 4.4. The most preferred embodiment of the invention also has a Texture score of at least 3, preferably at least 3.2, more preferably at least 3.4, more preferably at least 3.6, more preferably at least 3.8, more preferably at least 4.0, more preferably at least 4.2 and most preferably at least 4.4.

Two Phase Preference Test

In the first phase of the preference test, ten male and female Beagles were individually presented two diets simultaneously in two separate bowls for five consecutive days. One bowl, containing approximately 350 grams of Pedigree® Complete Nutrition Small Crunchy Bites Original Beef Flavor (the “Control” food designated “Kibble”), and a second bowl, containing 3 three pieces of the inventive pet food product (the “Test” food designated “Inventive Product”), were presented for 30 minutes each day. Each piece of the Inventive Product had a weight of approximately 130 grams and a water activity (A_{w}) of 0.9 or less. The Kibble included approximately 21% protein, with the protein from ingredients such as meat and bone meal, chicken by-product, and corn; approximately 9% fat, from ingredients such as beef tallow, vegetable oil, and the fat from the meat and bone meals; approximately 4% fiber, from ingredients such as corn and wheat; and 12% moisture.

Bowls were presented simultaneously and sides (left and right) were reversed daily. If one bowl was emptied prior to the end of the 30-minute period, both bowls were removed. Food consumption and first choice preference were recorded each day for each dog. At the end of the five days, all ten dogs were offered only the Inventive Product for ten days. At the end of the ten days, the second phase of the preference test was conducted in which the ten dogs were again presented the same two diets on an individual basis for five consecutive days according to the same procedure that was used in the first phase of the preference test.

The results showed that at the completion of Phase 2 of the test, the dogs preferred Inventive Product over the Kibble, more specifically at least 51% to 100% of the dogs preferred the Inventive Product over the Kibble, most specifically at least 51%, 54%, 56%, 58%, 60%, 65%, 70%, 75%, 80%, 85%, 90%, 95% and 100% of the dogs preferred the Inventive Product over the Kibble.

At the completion of Phase 2 of the test, Inventive Product was at least 51% to 90% of the total food intake, more specifically the Inventive Product was at least 53%, 55%, 57%, 59%, 60%, 65%, 70%, 75%, 80%, 85%, 90%, 95% and 100% of the total food intake.

Further, at the completion of Phase 2 of the test there was at least a 1% to 100% change in the number of dogs that preferred the Inventive Product over the Kibble, more specifically there was at least a 1%, 5%, 10%, 15%, 20%, 25%, 30%, 35%, 40%, 45%, 47%, 49%, 50%, 52%, 55%, 60%, 65%, 70%, 75%, 80%, 85%, 90%, 95% and 100% change in the number of dogs that preferred the Inventive Product over the Kibble.

Further, at the completion of Phase 2 of the test was at least a 1% to 100% change in the amount of Inventive Product intake as a percent of the total food intake, more specifically there was at least a 1%, 5%, 10%, 15%, 20%, 25%, 27%, 29.9%, 30%, 32%, 35%, 40%, 45%, 47%, 49%, 50%, 52%, 55%, 60%, 65%, 70%, 75%, 80%, 85%, 90%, 95%, and 100% change in the amount of Inventive Product intake as a percent of the total food intake.

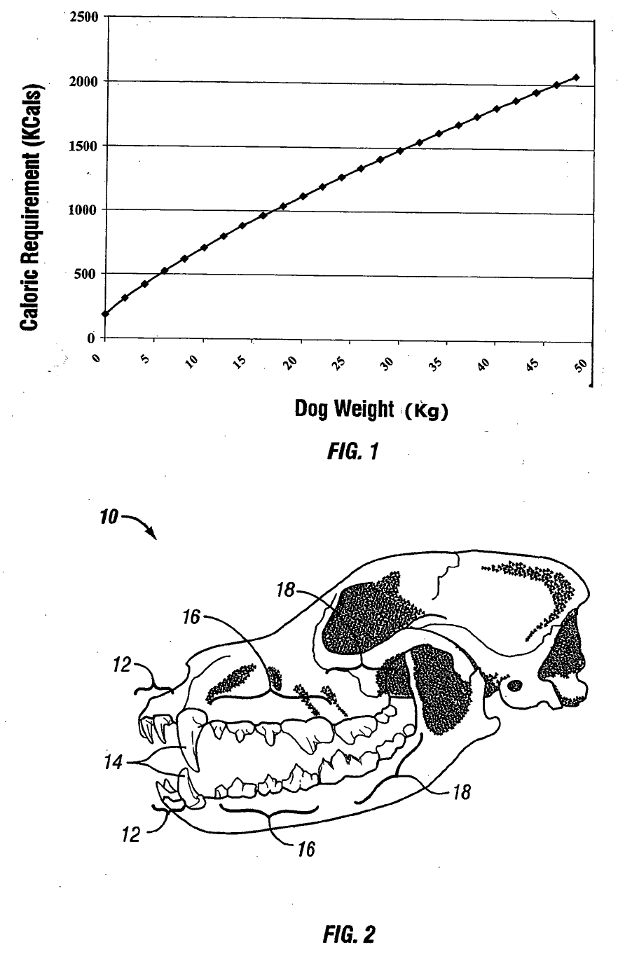

The pet food of the present invention is formulated to provide the daily nutritional and caloric requirements of an animal. Average required daily caloric intakes for dogs are based on their body weight. Average required daily nutrient intakes are generally based on caloric intake. The serving sizes of food generally vary according to a dog's weight or may be targeted for specific breeds, specific sizes of animals or ages of the animals. FIG. 1 illustrates the average required daily caloric intake for a dog based on the weight of the animal where caloric requirements is in Kcal and the dog weights are in kilograms. The equation for determining the values of the graph of FIG. 1 is Kcal/day=110×(Bodyweight in kg)⁰⁷⁵.

These nutritional requirements are met with three basic products: main meal pet food, snacks and treats. Main meal pet foods are usually sold as complete and balanced foods. Complete and balanced foods mean that when fed to an animal's caloric requirements for the animal's weight, the animal receives all of it's required daily nutritional and caloric requirements. Snack foods and treats on the other hand, may not meet these requirements for a number of reasons, such as missing one or more of the required nutrients, not providing the correct level of all of these nutrients and/or not providing enough calories to meet the animal's caloric requirements using the recommended serving size.

Main meal pet foods are generally either dry or wet products. Dry pet food products are typically bite sized, grain based extruded pieces (kibble) and are formulated to be complete and balanced. Dry products generally have a low moisture content of about 9% and are expanded during the manufacturing process, giving them a low density and a light texture. The density is typically around 0.80 g/mL. The composition and manufacture of these products make them rather brittle and easy to fracture. Dry kibble pet food is usually fed to the dog by placing the daily serving size into a bowl all at once or divided into separate feeding times over the course of the day until the total daily serving size is met. With dry kibble pet food there is no interaction between owner and animal and the animal is limited in the ways it can interact with the food. The pet food product of the present invention allows for increased interaction between the owner and the animal and the animal and the food. This results in increased enjoyment and well being for the animal.

Wet pet food products have a very high moisture content, above 70%, and therefore are sold in either cans or pouches that can withstand the required sterilization processes. These products are generally available in two forms, such as a loaf or chunks in gravy, which are also formulated to be complete and balanced. Loaf products have a homogenous meat base which is semi-liquid and may contain solid pieces of meat or vegetables. All or a portion of the package is emptied into a bowl for the animal to eat. The daily serving size can be given all at once or divided into separate portions and given over the course of the day until the total daily serving size is met. As with dry kibble, wet pet food provides no interaction between owner and animal and the animal is limited in the ways it can interact with the food. As discussed above, the pet food product of the present invention allows for increased interaction between the owner and the animal and the animal and the food. This results in increased enjoyment and well being for the animal.

One of the distinctive features of the present invention is its cohesiveness. As the animal bites off separate pieces of the pet food product for consumption, the pet food product remains predominantly intact. This is distinct from dry kibble and wet pet food in which the action of mastication brings about the destruction and/or deformation of the remaining piece of food. This cohesiveness results in a pet food that is not messy to feed as compared to other known pet foods, in addition to providing eating enjoyment to an animal.

The inventive product is designed to be eaten in more natural way then tradition kibble sized and shaped pet foods. A dog's teeth are configured such that the incisors are placed at the front of a dog's jaw and the longer canine teeth are placed on either side of the incisors. FIG. 2 is an illustration of a dog's skull 10 including the incisors 12, canines 14, premolars 16 and molars 18. As seen in FIG. 2, the height of the canines 14 is much higher than then the height of the premolars 16. Typical kibble shaped pet food pieces are generally small and designed to fit into the animal's mouth without having to be broken down into smaller pieces. However, the shape of the inventive product allows the dog's canines 14 to be able to penetrate the inventive product, which in turn forces the dog to chew the product in order to consume it. It has been found that dogs enjoy the chewing process such that they consume all or most of the inventive product in one sitting, which adds to the benefit of the eating enjoyment for the dog. This was substantiated in a two part preference test.

It has been found that dogs enjoy the chewing process such that they consume all or most of the inventive product in one sitting, which results in the preference of dogs to the inventive pet food product. The length of the inventive product is also a benefit to a dog's eating enjoyment as it allows the dog to be able to hold the inventive food product with its paws or appendages while eating it. Typical kibble dry pet food measures 1-3 cm in all dimensions. In the inventive pet food product, the length of the different sizes of products are proportional to the width of the jaws of various sized dogs. Thus, for weight ranges of various dogs, the preferred inventive product length for each weight range will have a ratio of at least greater than a 1:1 ratio of product length to jaw width, preferably a greater ratio of 2:1 of product length to jaw width, and most preferably between 2:1 and 5:1 of product length to jaw width. It is understood that the cross sectional area of the various sized inventive products will correspond to the different lengths of the respectively sized inventive products.

The dimensions of the preferred product embodiment are discussed below. It is clear that a combination of elements including size, length, cross sectional area, shape, and texture are key attributes in improving the interaction between the owner and animal. These element of feeding are clearly not present in the feeding of kibble.

In a preferred embodiment, the pet food product of the present invention is provided in a plurality of sizes for different sized dogs. The plurality of sizes is based on different weight ranges for each of the plurality of sizes. For example sizes designated such as small, medium, large and extra large may be provided. However, other size designations could include extra small, small-medium, medium-large, large-extra large, and extra extra large. The weight of the pet food product is in a range of about 20 to 400 grams per piece. The range of weights of the plurality of sizes of the pet food product could be between 20 to 55 grams per piece, 55 ,to 100 grams per piece, 100 to 250 per piece and 250 to 400 grams per piece. In one embodiment, a small sized product could have a length of 9.5 to 11.5 cm, and a weight range of about 40-50 grams, preferably a weight of 45 grams; a medium sized product could have a length of 11.5 to 13.5 cm and a weight range of about 67-82 grams, preferably a weight of 75.00 grams; a large sized product could have a length of 13.5 to 15.5 cm and weight range of 143-176 grams, preferably a weight of 155 grams; and an extra large sized product could have a length of 14.0 to 16.0 cm and a weight range of 250-270 grams, preferably a weight of 260 grams. It is contemplated that other embodiments would have different weight ranges within the range of 20 to 400 grams per piece.

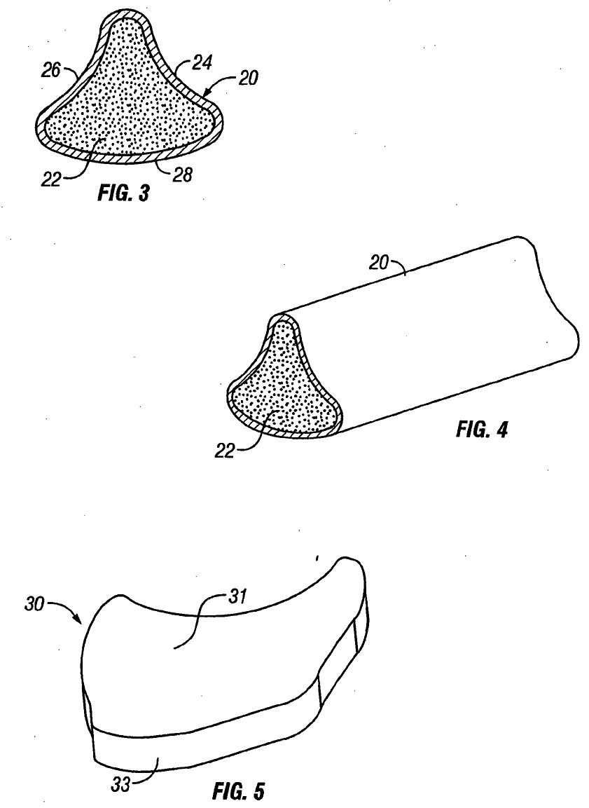

An example of the dimensions are as follows; The length, which is the longest dimension on the product, is greater than 5 cm, a preferred range is 5 to 25 cm, a more preferred range is 6.5 to 18 cm, and a most preferred range is 9.0 to 18 cm. The width, which is a dimension parallel to base 28 in FIG. 3, is in a range of 0.5 to 10 cm, a preferred range is 0.75 to 8 cm, a more preferred range is 1.0 to 7 cm, and a most preferred range is 2.0 to 6 cm. The depth, which is the smallest dimension between sides 24 and 26 of FIG. 3, is in a range of 0.5 to 10 cm, a preferred range is 0.75 to 8 cm, a more preferred range is 1.0 to 7 cm, and a most preferred range is 2.0 to 6 cm. The cross sectional areas range from 3.0 to 18.0 cm² in which a small product could have a cross sectional area of about 3.2 to 3.4 cm², a medium product about 4.3 to 4.6 cm², a large product about 7.7 to 8.2 cm2, and an extra large product about 12.9 to 13.6 cm². The preferred range of the cross sectional area is 0.75 to 25 cm², the more preferred range is 2 to 20 cm², and the most preferred range is 3.2 to 12.9 cm².

The design of the inventive pet food product also reduces and/or eliminates the risk of dogs choking while eating. Choking results from large particles or pieces of pet food lodging in the trachea of the dog. The inner component can be configured to crumble easily when detached from the outer component of the inventive pet food product by the act of chewing. The dimension of the product is also designed such that the product size recommended for a particular size or type of dog can have a cross-sectional area less than that of the average esophageal cross-section of that particular sized or type of dog in order to prevent the pet food product from lodging in the esophagus if a cross sectional piece of the product is swallowed whole.

A distinguishing feature of the preferred embodiment is the amount of time it takes a dog to eat the product, defined herein as “lasting time”. Dogs typically consume kibble in one of two ways. They can eat the kibble quickly with little or no chewing (5 minutes or less) or they can graze on kibble throughout the day (60 minutes or more) Because of the unique design of the present invention, specifically its texture, size, and caloric density, dogs are forced to chew the entire product in order to consume it. Further, the dogs enjoy the eating process such that they consume all or most of the inventive product in one sitting. As a result, the lasting time per piece of the present invention is significantly different to that of kibble, and directly results in increased new and different dog enjoyment perceptions with consumers.

Lasting time is measured by asking participants were asked how long it takes their dog to consume the inventive product when compared to their dog's normal food, i.e. kibble. Participants observing their dogs recorded lasting times for all pet food products in the test. Lasting time was recorded based on participants' perception as a response to the question “Approximately how long (please put in minutes) does it take your dog to consume the product?” in combination with “How long did it take your dog to eat (the test product) compared to their regular food?”. It was found that lasting time is directly related to animal satisfaction. The average of the responses was taken as the lasting time. It was found that lasting time is generally 2 to 60 minutes, preferably lasting time is 4.5 to 50 minutes, more preferably 5 to 40 minutes, and most preferably 6 to 25 minutes.

The texture, size and width of the food product force the dog to thoroughly chew the product. Increased chewing stimulates saliva flow and saliva is a natural cleansing agent for the mouth thus helping to improve oral health. In addition, the width and texture of the product as such that it allows increased contact between the teeth and the food while the animal is chewing. The texture cleans the tooth by mechanical abrasion. Because dogs can eat typical dry food kibble with little to no chewing, feeding the pet food product to the animal will provide improved oral hygiene benefits to the animal because of the size, shape and texture of the product.

The lasting time of the product is directly related to the textural attributes of the product. The present invention also has specific textural qualities that can be defined as hardness, brittleness and toughness. The method of measuring texture is the same for both the inner and outer components.

Texture measurements were performed with a TA.HDi Texture Analyzer (Texture Technologies Corp., Scarsdale, New York) equipped with a 500 kg load cell. A four inch cylindrical probe and triple point bending rig were used and the tests were conducted at a room temperature of 25° C. Data was collected using the Texture Expert software (version 2.12) from Texture Technologies Corp. Two different tests were run, a uniaxial puncture test and a triple point bending test. These tests were selected because they best resemble the biting and chewing of the test samples by dogs.

The triple point bend and puncture analysis parameters are as follows. Work (W) is defined as an estimate of work; and therefore shows the toughness of the product. A tough product will have a higher bend work value than a less tough product. The area shows the “force” or load that must be applied to the product to cause it to break. The expressed “Area” units come from the multiplication of y-axis per x-axis as kg/mm. To convert “Area” to Work—W−(F/d) multiply by 0.1020408 m²/mm/s².

The Max Force (N) is defined as the maximum amount of force needed to overcome the product's hardness. Usually a hard product will be associated with high ordinate (y-axis) values. The expressed “Force” unit derives from a direct association with mass weight in kg. To convert “Force” to “Max Force”—N—multiply by 9.81 m/s² (the acceleration of gravity).

Travel (mm) is represented as the point (distance) at which the peak force is reached. Thus it emulates the resistance of the product as a combination between toughness and hardness, in addition to elasticity, attributed to a measurement of how far the probe has traveled to reach the maximum force. Resistance is directly proportional to travel values.

Linear Distance (mm) is calculated by measuring the length of an imaginary line pulled taunt joining all the trajectory points. It is a direct assessment of brittleness where a brittle product will produce more sharp peaks, resulting in a higher linear distance. A softer product can have the same base and height curve of a brittle product but less jagged peaks, hence reducing the linear distance value.

The values of hardness, brittleness and toughness were determined using a triple point bending rig for testing whole product samples. A triple point bend rig, such as the TA.HDi, provided by the Texture Technologies, was used to measure force/distance. The test rig is adjusted to a width of 10 cm. The product samples are tested as they are, such as illustrated in FIGS. 3 and 4, and no cutting is required. The samples tested were 13 cm long, 4.4 cm high, about 5.3 cm wide in the widest section or third side 28 and about 0.5 cm wide in the narrowest section which is where the first and second sides 24, 26 join at the top of the product.

The sample 68 is centered on the test rig such that the knife 70 will contact the narrowest point of the sample at a direction 72 of a 90° angle while the sample is laying with its third side 28 placed on a flat surface as illustrated in FIG. 10.

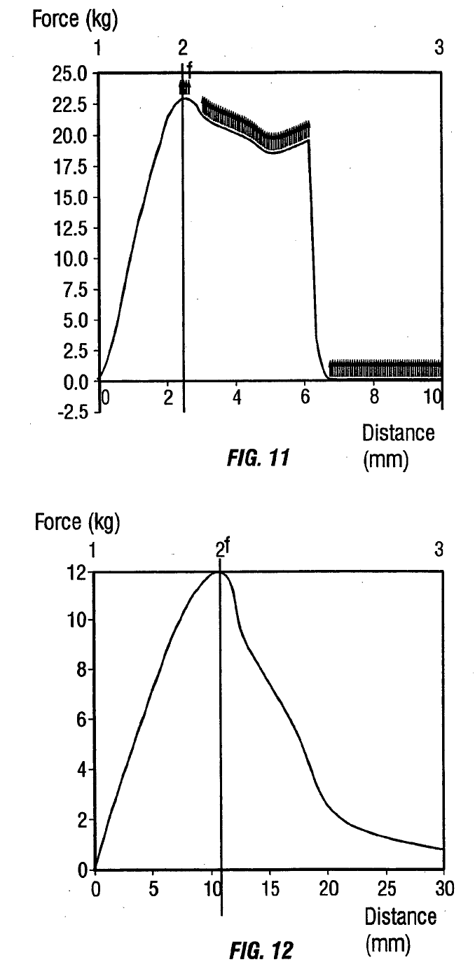

The probe or knife 70 is run at a (1) pre test speed of 2.0 mm/s (speed of probe before contacting sampling); (2) a test speed of 1.0 mm/s (speed of probe while travelling within the sample); (3) a post test speed of 2.0 mm/s (speed that the probe is withdrawn from the sample); and a distance of 30 mm (distance that probe travels within the sample until it is withdrawn). This distance translates to 67-69% strain. The force in kg (y axis) is plotted against distance in mm (x axis) in which the starting force of 0 is 1 and the Max Force is 2 (FIG. 11). The following parameters were measured: the Max Force 2, which is the maximum force value of the curve, is a measurement of hardness; the Linear Distance (mm), is calculated by measuring the length of an imaginary line pulled taunt joining all the trajectory points. It is a direct assessment of brittleness where a brittle product will produce more sharp peaks, resulting in a higher linear distance. For each of these parameters, the measurement was the average of the values of at least 10 samples of the product tested.

Hardness is measured as Max Force in kg. As measured in the triple bend test, the hardness or max force value of the inventive product has a range of 70 to 520 N, a preferred range of 75 to 320 N, and a most preferred range of 105 to 260 N. The hardness value of the outer component, as measured by the puncture and penetration test, has a range of 50 to 300 N, a preferred range of 55 to 1230 N and a most preferred range of 90 to 130 N. The hardness value of the inner component, as measured by the puncture and penetration test, has a range of 500 to 2760 N, a preferred range of 90 to 1550 N, and a most preferred range of 100 to 170 N.

The toughness of the outer and inner component was also measured. In the three point bend tests, the toughness or work value of the inventive product has a range of 0.5 to 5.5 W, a preferred range of 0.55 to 4.7 W, a more preferred range of 0.6 to 4.4 W, and a most preferred range of 0.95 to 3.1 W. The toughness or work value of the outer component, as measured by the puncture and penetration test, has a range of 0.01 to 0.5 W, a preferred range of 0.05 to 0.4 W, and a most preferred range of 0.10 to 0.2 W. The toughness or work value of the inner component, as measured by the puncture test, has a range of 0.30 to 3.4 W, a preferred range of 0.35 to 3.0 W, and a most preferred range of 0.45 to 1.0 W.

The brittleness or bend linear distance of the inventive product was measured by the triple bend test. The brittleness value of the inventive product has a range of 430 to 1160 mm, a preferred range of 460 to 815 mm, and a most preferred range of 500 to 700 mm.

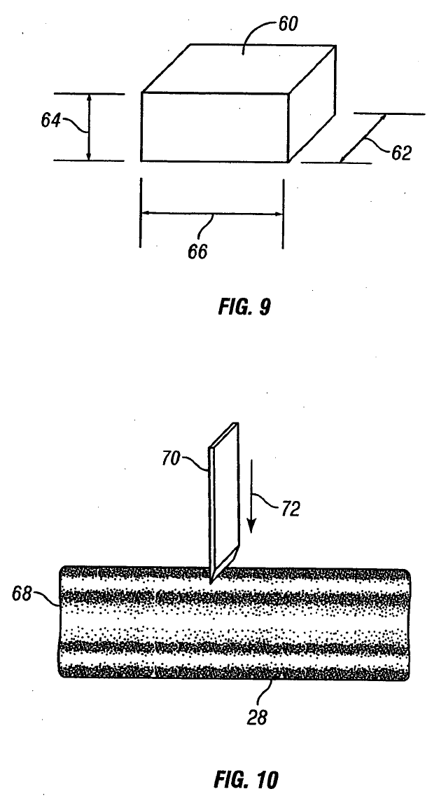

For the uniaxial puncture test, the test product 60 was cut into a sample size in the shape of a cubic prism having a length 62 of approximately 2 cm, a depth 64 of approximately 0.5 cm and a width 66 of approximately 2 cm as illustrated in FIG. 9.

A puncture test was run measuring force over distance using a piece of equipment such as the TA.HDi Texture Analyzer. The puncture and penetration test provides information regarding the amount of force needed to overcome the product's hardness, the force or load that must be applied to the product to cause it to break, as well as the crunchiness of the sample. The settings for the test should be 4 mm cylindrical TA-55 probe and Metal flat plate, TA-90A. The probe speed should be 1) pre test speed of 2.0 mm/s; 2) test speed of 1.0 mm/s; 3) post test speed of 2.0 mm/s; and 4) run probe to 30% strain. The sample is tested along the 0.5 cm dimension, which is lying flat on the test surface.

The force in kg (y axis) is plotted against distance in mm (x axis) in which the starting force of 0 is 1 and the distance in mm of the first major failure is 2 (FIG. 12). The parameters of fracture force or hardness, the gradient and the area between 1 and 2 (toughness) are used. The first peak force (2) is measured, which is the fracture force or hardness. The second measurement is the area under the curve with respect to the first fracture (area between 1 and 2), which is the toughness. This area corresponds to the work necessary to induce the first major failure of the sample and expresses the ability of the material to absorb mechanical energy prior to failure. The hardness measurement for the product is the average of at least 10 samples, and the toughness measurement is the average of at least 10 samples of the test product.

As discussed above, the pet food of the present invention is formulated to provide the daily nutritional and caloric requirements of an animal. The average required daily caloric intakes for dogs are based on their weight (FIG. 1). Average required daily nutrient intakes are generally based on caloric intake. The required serving sizes of food and thus total daily calories, can vary according to a number of factors. These factors include an animal's weight, the specific size of the animal, the specific breed of an animal, all lifestages of an animal (including but not limited to growth, adult maintenance, senior, pregnancy, lactation),activity level of the animal, body condition of the animal (feed for weight gain of a thin animal and feed for weight loss of a heavy animal), health status of an animal (including but not limited to obesity, thyroid condition, renal condition, etc.) or total daily energy requirements of an animal.

Each of the pieces of the inventive pet food is formulated to have a specific caloric content which 1) will meet the animal's nutritional requirements within the product's recommended serving size, 2) is designed with a serving size that will provide a satisfying meal for the animal and 3) is designed with a serving size that the animal can consume in a reasonable amount of time within a day. The inventive product is specifically designed to provide certain eating times, i.e. be consumed in a certain amount of time, which effects an overall “lasting time” score.

The inventive product provides a feed method to address a number of feed issues found in animals and in particular dogs. One feed method provides for a means to control the rate/speed of food intake by feeding the animal the inventive product which results in increased chewing as illustrated in the overall “lasting time” score. This feeding method can control conditions such as bloat and gastric torsion in an animal. The increase in chewing time can also provide a feeding method that addresses separation anxiety and destructive chewing behavior in an animal such as a dog.

The inventive product provides a feeding method that allows for control of the caloric intake of an animal's food, which in turn provides for a method of weight management (either an increase in food intake or a decrease in food intake) of an animal. The highly palatable nature of the inventive product provides for a method of increasing the caloric intake of an animal by enticing the animal, such as a dog, to eat an amount of the inventive product that will meet the animal's daily nutritional requirements. Also, the longer lasting time of the inventive product provides for a method of reducing the caloric intake in an animal by inducing satiation and thus reducing the incidence of overeating.

Each piece of the inventive pet food product provides a specific amount of calories per piece, caloric density per piece and kcal per gram in each piece. The amount of calories per piece of the inventive product is between 20 and 2500 kcal, preferably between 30 and 2500, most preferably between 50 and 2500 kcals. Other ranges can include a range of 40 to 1500 kcal, more preferable in the range of 60 to 1000 kcal, and most preferably in the range of 80 to 800 kcal per piece. Therefore, a small sized product could have about 135 kcal per piece, a medium sized product could have about 226 kcal pre piece, a large sized product could have about 467 kcal per piece, and an extra large sized product could have about 783 kcal per piece.

The caloric density is in the range of 1.8 to 11.1 kcal/cm³, preferably in the range of 2.5 to 8.0, more preferable in the range of 3 to 6, even more preferably in the range of 3.2 to 4.5, and most preferably in the range of 3.5 to 4.0 kcal/cm³. The kcal per gram of each piece of the inventive pet food product is 1.4-8.4 Kcal/g, preferably in the range of 1.8 to 7, more preferably in the range of 2 to 6, even more preferably in the range of 2 to 4, and most preferably in the range of 2.2-3.5 kcal/g.

An approximate feeding guide utilizing the inventive pet food product for various sized dogs could be established by determining the estimated caloric requirement for dogs based on the equation described in paragraph 055. The average caloric requirements would result in the following feeding system. In one embodiment, a small sized product could be designed for dogs weighing generally between 7 and 31 lbs. (3.2-14.1 kg) and about 2-6 pieces (270-810 total calories) of the inventive pet food product per day would provide the complete and balanced daily nutritional requirements of a dog in this weight range. A medium sized product could be designed for dogs weighing generally between 14 and 62 lbs. (6.4-28.1 kg) and about 2-6 pieces (452-1356 total calories) of the inventive pet food product would provide the complete and balanced daily nutritional requirements of a dog in this weight range. A large sized product could be designed for dogs weighing generally between 38 and 96 lbs. (17.2-43.5 kg) and about 2-4 pieces (934-1868 total calories) of the inventive pet food product would provide the complete and balanced daily nutritional requirements of a dog in this weight range. An extra large sized product could be designed for dogs weighing generally between 76 and 192 lbs. (34.5-87.1 kg) and about 2-4 pieces (1566-3132 total calories) of the inventive pet food product would provide the complete and balanced daily nutritional requirements of a dog in this weight range.

In one embodiment of the present invention a two component pet food product has a length of 15 cm, a diameter at its broadest point of 3.86 cm and a cross sectional area of 6.45 sq. cm. This sized product can have a hardness range of about 208-478 Max Force; a brittleness range of about 557-829 mm; a toughness range of about 2,9-4.6 Work; a range of 2 to 4 calories per gram; and a caloric density range of 3 to 4 per unit volume, preferably 2 to 3 per unit volume.

Another attribute of the present invention is its shelf stability. A product has shelf stability when it is safe for consumption and maintains an acceptable quality when stored at room temperature. Four major agents contribute to the deterioration of foods: microbial, enzymatic, chemical and physical phenomena.

Microbial activity relates to food spoilage that results in the deterioration of the aesthetic properties of the food, such as flavor, appearance, texture and odor. In shelf-stable products microbial problems can be controlled by the formulation of the product, the process of manufacturing the product or a combination of the two. Reducing the water activity below 0.6 effectively curbs microbial growth. Other options for reducing water activity include using a humectant, such as propylene glycol or glycerin. An ingredient like fat can provide the perception of moistness.

Enzymatic activity can produce proteolysis and oxidation which can occur at temperatures slightly elevated from ambient room temperature. Chemical reactions also create a number of results affecting the quality of shelf-stable products. One major problem is oxidation and its many undesirable consequences: off flavors, nutrient loss, changes in appearance, etc.

When a food product is exposed to oxygen in the air, oxidative chemical reactions often occur. Oxygen attacks the structure of a molecule and the result is generally not positive: oxidative rancidity of lipids, destruction of oxygen-sensitive vitamins, such as ascorbic acid, and color changes are a few of the outcomes. Oxidative rancidity of lipids occurs when oxygen reacts with an unsaturated bond in the fat to form a free radical. This initiates a chain reaction, resulting in the formation of aldehydes, ketones, fatty acids and alcohols that produce the off-flavors and odors that characterize fat rancidity. Antioxidants interfere with this reaction by donating a hydrogen to the fat or peroxide free radical creating a stable compound that no longer continues the reaction.

The level of oxidation is determined by typical methods such as active oxygen bomb determinations and the physical measurement of the by products of the chemical degradation cycle such as peroxides. Measurements are made as to whether the product is acceptable or not. Peroxide values of less than 20 are preferred as described in Bailey's Industrial Oil and Fat Products, Volume 1, Fourth Edition. A method for determining the peroxide value can be found in the AOCS Official Method Cd 8B-90 (1997), titled Peroxide Value Acetic Acid-Isooctane Method.

The oxygen bomb method is utilized to assess oxidative stability for dry pet food ingredients and diets. The samples are sealed in a stainless pressure vessel, which is charged with 50-60 psi oxygen. The vessel is immersed in an oil bath at 100° C. for up to 40 hours. Oxygen absorption is monitored as a direct indication of the oxidation rate. This test is used to approximate shelf life and to determine how fast the sample is oxidizing. The interpretation of the results is product dependent. The value recorded is similar to the Oil Stablitity Index (OSI) which is an AOCS Official Method Cd 12b-92 (1997). The time in hours when the slope changes gives a number that relates to the approximate shelf life. Each hour is equal to 1 month. A value less than 12 should have 12-month shelf life.

Preferably, the oxygen bomb of the inventive product is 0 to 20 hrs and the peroxide value is 0 to 40 meq/Kg.

One component of the inventive pet food product can optionally be formed from dry and liquid ingredients. The dry ingredients can include flours such as corn, wheat, rice, barley, oat, legumes etc., individual meals such as bone, chicken, beef, or poultry or combinations thereof, vitamins, minerals, sugars, hydrocolloids and colorant. The liquid ingredients can include water, fats, oils, glycerol, antioxidants, emulsifiers, liquid sugar, etc. The combination of ingredients that are used for this component produce typically form a component that has a dry and granular texture.

A second component can optionally be formed from a meat mixture of different meats such as chicken, beef, pork, lamb or combinations thereof and dry ingredients including flours and/or starches such as wheat, barley, corn, rice, and oats, corn, wheat, rice, potato, and tapioca, gums, colors, and vitamins and minerals.

Starch, protein, fiber and fat are important primarily for nutritional purposes. Levels and types of starch, protein, fiber and fat also effect texture, flavor, caloric density, calories pre gram and other qualities of the inventive pet food product.

Carbohydrates are certain organic compounds that include sugars, starches and celluloses. Carbohydrates are important in providing the proper nutrient/caloric content, structure and texture to the product The starch source is also important in this embodiment for appearance. The preferred sources in the present invention are rice and/or corn, and corn gluten.

The protein source can be either animal or vegetable or a combination of both. Preferably the product contains both an animal and a vegetable protein. The preferred sources in this embodiment are a vegetable source such as corn gluten and an animal source such as chicken meal. Protein provides nutrition, structure and texture to the inventive pet food.

The type and source of fiber is important in the present invention in order to prevent crumbliness. The source can be from plant or cereal. The preferred source is cellulose having a long fiber length.

The fat source is important for product texture and for cleanliness of feel for the consumer. The preferred sources are oils such as corn.

Humectants are important to lower the water activity for microbiological stability. The preferred source is glycerin and the preferred range is 0% to 10%, the more preferred range is 1-4% and the most preferred range is 1-3%.

Other ingredients in the inventive pet food include antioxidants, eg BHA and BHT, that retard the oxidation process that can result in spoiled product. Mold inhibitors such as Potassium Sorbate, that prevent or retard the growth of yeasts and moulds that result in product spoilage, can be included. Ingredients that control water activity can be included. An example of these ingredients are glycerine and propylene glycol that also help in the process of managing the spoilage organisms such as yeasts and moulds. Texture modifiers, such as cellulose can be added in which altering the addition levels can affect the textural characteristics of the product. Vitamin preblends, that manage the correct levels of vitamins and minerals that are required to provide a balanced daily diet for the dog can also be added. Specific ingredients can be added to create functional inventive pet food products. Examples of these ingredients include but are not limited to green lipped mussel, glucosamine, chondroitin, MethylSulfonyMethane, antioxidants, and fatty acids for joint health; high protein, low fat and fiber for weight management; and linoleic acid, biotin, zinc, omega 3 fatty acids and flaxseed for improved skin and coat.

The present invention has a moisture range of 9 to 32%, a preferred moisture range of 12 to 28%, a more preferred range of 14 to 24% and a most preferred range of 16 to 22% moisture. The water activity (Aw) of the present invention is less than 0.9, preferably 0.5 to 0.9, more preferably 0.6 to 0.85 and most preferably 0.65 to 0.80.

The protein content of the present invention is greater than 15 wt %, preferably 15 to 65 wt %, more preferably 15 to 35 wt % and most preferably 18 to 25 wt %.

The carbohydrate content is 30 to 70 wt %, preferably 35 to 50 wt % and most preferably 40 to 45 wt %.

The fat content of the pet food of the present invention is greater than 3 wt %, preferably 3 to 20 wt %, more preferably 3 to 10 wt % and most preferably 3.5 to 8 wt %.

The fiber content is 0 to 10 wt %, preferably 0.5 to 9 wt %, more preferably 1.0 to 8 wt %, most preferably 2.0 to 8.0 wt %, and even more preferably 3.0 to 8.0%.

As with any intermediate moisture products, humectants are used to lower the water activity below levels where molds, yeast and bacteria can grow. The methods and processes of mixing and blending these ingredients is well known to one skilled in the art of food processing.

Additionally, both components can be made from the dry and liquid ingredients that form a dry and granular component or both components can be made from the meat mixture ingredients.

The pet food product of the present invention can be formed as a single component or at least a two component product. The at least two components can differ in caloric density, texture, composition, color, flavor, and ratio of an inner component to an outer component. For example, the inner and outer components can both have the same caloric density or the inner and outer components can have different caloric densities. Additionally, the components can be the same or different colors or the same or different flavors. Color or flavor can also be utilized to define two components. The components can have different functionalities or can deliver different function benefits.

In one preferred embodiment one of the at least two components has one of a caloric density, hardness, brittleness, toughness, elasticity, density, calories per gram that is at least 2% greater than another of the at least two components. More preferably it is at least 2% greater, even more preferably 6% greater, even more preferably 10% greater, even more preferably 15% greater and most preferably 20% greater.

One embodiment of the present invention is a product formed as two components in which one component 20 surrounds the other component 22 (FIGS. 3 and 4). Preferably, this embodiment has the cross sectional shape of a distorted triangle in which a first side 24 and a second side 26 are concave and the third side 28 convex (FIG. 3). In one embodiment, the two components can be distinguished by color in which the inner component is a darker color than the outer component.

Another embodiment can be in the form of a single component 30 in shapes resembling meat pieces such as pork chops or slices of beef (FIG. 5). An example of the ingredients for a single component pet food product are listed in Table 7. This embodiment can also be colored to give,the impression of two textures. The color and surface of this embodiment is such that is simulates the color and texture of a slab of meat. This can be accomplished by varying the color on the surface, the smoothness or the texture of the surface, and/or the texture of the interior of the inventive pet food product. As a result, the inventive product can be at least one color or several colors and can be at least one texture or several textures. A single texture embodiment can be a single color product where the intensity of the color varies throughout the product. Alternatively, the product could include a rough or textured outer surface. An example of a multi textured product would include a meat-like component as described previously and a second component that simulates a bone or a fat component of a slab of meat.

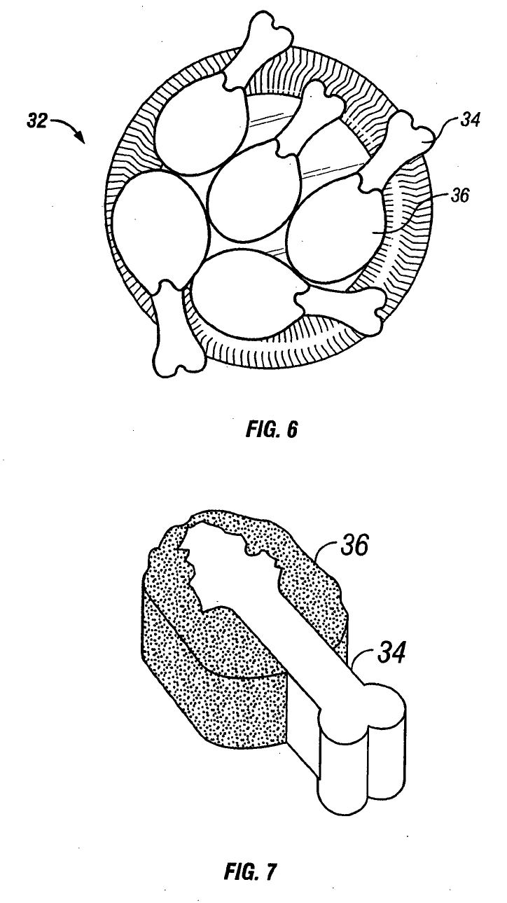

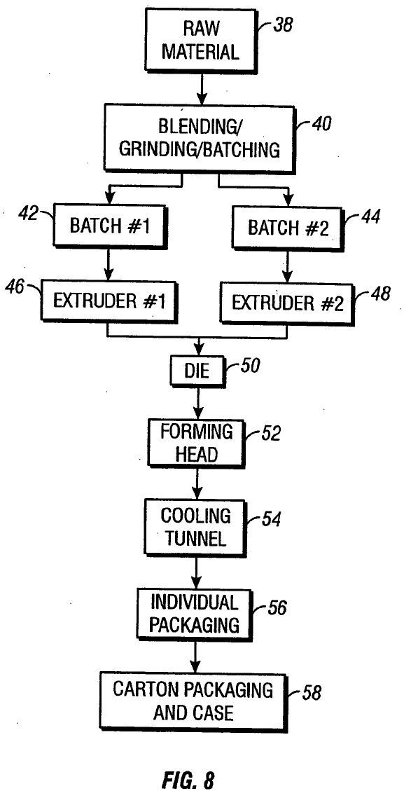

Another embodiment of the inventive product can be in shape resembling a “chicken drumstick” wherein a meaty material is wrapped around a bone-like inner component. In this embodiment the two texture pet food can be in the shape of a either a chicken or turkey drumstick 32, having an inner bone-like component 34 and an outer meaty component 36 (FIGS. 6 and 7). Preferably, the outer meaty component 36 is wrapped around the inner bone-like component 36 either completely or partially. The color of the outer component can be darker in hue than the inner component.

In this embodiment, the inner component 34 is generally formed from dry and liquid ingredients. The dry ingredients can include flours such as corn, wheat, rice, barley, oat, legumes etc., individual meals such as bone, chicken, beef, or poultry or combinations thereof, vitamins, minerals, sugars, hydrocolloids, colorant and flavours. The liquid ingredients can include water, fats, oils, glycerol, antioxidants, emulsifiers, liquid sugar, etc. The combination of ingredients that are used for the inner bone-like component produce a component that has a dry, crumbly and granular texture.

In this embodiment, the outer component 36 is generally formed from a meat mixture of different meats such as chicken, beef, pork, lamb or combinations thereof and dry ingredients including flours and/or starches such as wheat, barley, corn, rice, and oats, corn, wheat, rice, potato, and tapioca, gums, colors, flavors, and vitamins and minerals. Since the outer component is meaty and formed from predominantly, but not limited to meat based ingredients, the texture of the outer meaty component can be fibrous and linear.

In this embodiment, the inner bone-like component is a semi-moist food product and as such, any semi-moist pet food formulation known to one of skill in the art can be used. For example, the subject inner bone-like component may have a moisture content in the range of about 12% to about 20%. The inner bone-like component also includes, on a dry matter basis, at least about 17% by weight of protein, about 2% to about 10% by weight of fat and at least about 60% by weight carbohydrate. It is also preferable that the inner bone-like component has a water activity, A_{w}, of at least about 0.8 or greater, and more preferably, in the range of about 0.8 to about 0.83.

In this embodiment, the outer meaty component is a semi-moist food product and as such, any semi-moist pet food formulation known to one of skill in the art can be used. For example, the subject outer meaty component may have a moisture content in the range of about 10% to about 30%. The outer component also includes on a dry matter basis, about 10% to about 20% by weight of protein, about 2% to about 10% by weight of fat and about 40% to about 78% by weight carbohydrate. It is also preferable that the outer meaty component has a water activity, A_{w}, of at least about 0.8 or greater, and more preferably, in the range of about 0.9 to about 1.0.

FIG. 8 illustrates a flow diagram of an extrusion process that can be used to manufacture the present invention. In the preferred embodiment, this process involves two extruders (twin or single). One extruder produces the inner component and the second extruder produces the outer component. Flow streams coming from each extruder are converged into a common die with a specially designed opening. In one embodiment, the outer component can extruded so as to surround the center extruded inner component. The product comes out of the die, is cut and conveyed to further processing including, but not limited to, baking, retorting or irradiating. The process steps are described with reference to an automated assembly line in a food processing facility. However, it should be understood that an automated assembly line is not necessary to practice the invention described herein, and that all or a subset of the steps may be performed in a non-automated manner.

In the forming of a two component product, processing generally begins with placing the selected raw materials 38 through a blending, grinding and batching process 40. In this process 40 the raw materials are typically placed in a hopper. A pump pumps the contents of the hopper into a mixer where a variety of other ingredients may also be introduced. For example, it may be desirable to mix the starting ingredient with one or more of a coloring agent, flavoring agents, and one or more vitamins. The ingredients are combined in the mixer, which may include grinding of some of the raw materials, for a time period sufficient to adequately distribute all ingredients throughout the resultant mixture. The blending, grinding and batching process 40 may include at least one and preferably two separate blending, grinding and batching processes 40, depending upon the ingredients of the inner and outer components. For example, if the ingredients of the inner and outer components are different, two separate blending, grinding and batching processes will be necessary.

After the raw materials have been mixed and blended, they are separated into two batches, batch one 42 and batch two 44, for processing through two extruders 46, 48 or one twin extruder. The material moves through the extruder(s) 46, 48, through a die 50 that preferably provides a specific texture on the outside surface of the present invention and through a forming head 52 that gives the inventive pet food product a specific shape. After exiting the forming head 52, the product may be processed through a cooling tunnel 54 before packaging. The product is then individually packaged 56 and thereafter is processed through carton and case packaging 58 as is known to one skilled in the art.

Alternatively, the inventive pet food product could include an expanded outer and/or inner component. The expanded component would have the appearance of an aerated material. The expansion of the outer or inner component can be achieved by a number of means known by those skilled in the art. The expanding means could include for example, increasing pressure, increasing temperature and increasing the working of the material in the extruder barrel by means of the addition of steam and/or temperature and/or shear and/or mechanical energy, etc. A combination of any or all of these influences will result in certain of the ingredients in the pet food product, such as water, glycerine and propylene glycol, to flash when the extrudate exits the extruder. The exiting of the material from conditions of elevated pressure and temperature to ambient conditions, results in flashing, which causes the extrudate to expand. This expansion could be increased for example, by passing the extrudate through an expansion chamber, operated under vacuum, after the extrudate leaves the extruder. The expanded component would reduce the density of the inventive pet food product and consequently the caloric content of the pet food product would also be reduced.

A second means for achieving the appearance of an aerated material could include the use of a single extruder for the two component product. In the single extruder, the flow of the extrudate can be split near the end of the barrel and color can be added to one side of the split extrudate before the two flows of extrudate are recombined prior to exiting the extruder.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

One embodiment of the present invention is a two component pet food product having a longitudinal shape and a cross sectional shape in the form of a modified triangle (FIGS. 3 and 4). The two component pet food product has outer and inner components 20, 22. In a preferred embodiment, the inner component 22 can have the perception of a meaty-like center formed from real or artificial ingredients. An exemplary example of recipe of ingredients is listed in Table 1.

TABLE 1

| Ingredients for the inner component | % of component | % of total |
|---|---|---|
| Chix By-Product Meal (BHA/BHT) | 25.95 | 15.57 |
| Rice Brewers | 43.60 | 26.16 |
| Corn Gluten Meal | 6.03 | 3.62 |
| Whole Corn | 8.62 | 5.17 |
| Potassium Sorbate | 0.21 | 0.13 |
| Petox Plus | 0.06 | 0.04 |
| Vitamin Preblend | 1.72 | 1.03 |
| Glycerine | 4.31 | 2.59 |
| Oil Corn | 2.59 | 1.55 |
| Water | 6.90 | 4.14 |
| Total | 100.00 | 60.00 |
| Ingredients for the outer component | % | % |
| Rice Flour | 56.13 | 22.45 |
| Wheat Gluten | 9.59 | 3.84 |
| Cellulose | 1.92 | 0.77 |
| Petox Plus | 0.07 | 0.03 |
| Water | 11.51 | 4.60 |
| Heat Treated Flour | 6.04 | 2.42 |
| Sodium Caseinate | 1.38 | 0.55 |
| Sugar | 7.10 | 2.84 |
| Poultry Liver Digest Powder | 0.17 | 0.07 |
| Potassium Sorbate | 0.34 | 0.14 |
| Calcium Carbonate | 1.15 | 0.46 |
| Salt, Iodized | 0.68 | 0.27 |
| Sodium tripolyphosphate | 1.94 | 0.77 |
| Potassium Chloride | 0.96 | 0.39 |
| Choline Chloride | 0.20 | 0.08 |
| Vitamin Preblend | 0.84 | 0.34 |
| Total | 100.00 | 40.00 |

Table 2 illustrates other qualities of the two component pet food product of Example 1.

TABLE 2

| Qualities | Small Product | Medium Product | Large Product |
|---|---|---|---|
| Hardness (N) | | | |
| Max Force¹ | 99.6-178.2 | 208.4-478.7 | 287.4-367.8 |
| Puncture and | | | |
| Penetration: | | | |
| outer component | 35.6-128.7 | 148.4-277.3 | 67.2-141.0 |
| inner component | 51.0-205.6 | 71.4-759.8 | 203.1-279.0 |
| Brittleness (mm) | | | |
| Linear Distance | 465.1-578.0 | 557.2-829.6 | 651.8-920.4 |
| Toughness (W) | | | |
| Work¹ | 0.13-2.65 | 2.99-4.69 | 2.94-5.34 |
| Puncture and | | | |
| Penetration: | | | |
| outer component | 0.01-0.12 | 0.06-0.47 | 0.08-0.28 |
| inner component | 0.36-0.85 | 0.30-3.32 | 1.09-1.93 |
| Calories per gram | 2.80 | 2.80 | 2.80 |
| Caloric Density | 3.70 | 3.70 | 3.70 |
| per unit volume | | | |
| (kcal/cm³⁾ | | | |
| Caloric Content | 221.20 | 392.00 | 658.00 |
| of a piece | | | |

¹Measured by Three Point Bend Test

Table 3 illustrates the results of the Two Phase Preference Test for the inventive two component pet food product having a weight of about 130 grams.

TABLE 3

| | Phase 1 | | Phase 2 | | | |
|---|---|---|---|---|---|---|
| | No. of dogs | | No. of dogs | | | |
| | preferring | | preferring | | Change during study | |
| | this | % Consumed | this | % Consumed | No. of | % Consumed |
| Product | Product | of total intake | product | of total intake | Dogs | of total intake |
| Kibble | 5 | 70.9 | 3 | 41 | −2 | −29.9 |
| (Control) | | | | | | |
| Inventive | 2 | 29.1 | 6 | 59 | +4 | +29.9 |
| Product | | | | | | |
| (Test) | | | | | | |

Table 4 illustrates further attributes of the two component pet food of Example 1.

TABLE 4

| | Question - How much do you agree with the following | BI average score |
|---|---|---|
| Attribute | statements? | and (range) |
| Uniqueness | Is a revolutionary way to serve your dog meals. | 4.4 |
| | | (4.2 to 4.7) |
| Mess | Is not messy. | 4.3 |
| | | (4.2 to 4.5) |
| Well-being | Provides a fun and enjoyable experience for your | 4.2 |
| | dog. | (4.0 to 4.7) |
| | Is a food that will improve your dog's well-being. | 3.9 |
| | | (3.8 to 4.1) |
| | Total Attribute score | 4.05 |
| Occupation | Keeps your dog occupied for a longer time. | 4.2 |
| | | (4.0 to 4.3) |
| Convenience | Is appropriate for everyday use | 4.1 |
| | | (3.9 to 4.5) |
| | Makes feeding the right amount easy | 4.1 |
| | | (3.8 to 4.4) |
| | Total attribute score: | 4.15 |
| Chewing | Satisfies your dog's need for chewing. | 4.3 |
| Satisfaction | | (4.1 to 4.7) |
| Texture | Has a texture your dog would like. | 4.1 |
| | | (3.9 to 4.7) |

Another example of a recipe of ingredients for a two component pet food product of the present invention is shown in Table. 5.

TABLE 5

| Ingredients for the outer component | % of component | % of total |
|---|---|---|
| Poultry Meal | 37.81 | 15.13 |
| Rice Flour | 32.11 | 12.85 |
| Water | 6.97 | 2.79 |
| Cellulose | 4.25 | 1.70 |
| Glycerine | 3.69 | 1.47 |
| Sugar | 3.30 | 1.32 |
| Oil Corn | 2.87 | 1.15 |
| Poultry Liver Digest Powder | 2.18 | 0.87 |
| Sodium Caseinate | 2.18 | 0.87 |
| Propylene Glycol | 1.72 | 0.69 |
| Red Blood Cells, Dried | 1.38 | 0.55 |
| Dicalcium Phosphate | 0.83 | 0.33 |
| Salt, Iodized | 0.41 | 0.17 |
| Potassium Sorbate | 0.19 | 0.07 |
| Zinc Oxide | 0.06 | 0.02 |
| Anti-Caking Agent | 0.05 | 0.02 |
| | 100.00 | 40.00 |
| Ingredients for the inner component | % | % |
| Rice Flour | 44.88 | 26.93 |
| Sugar | 11.26 | 6.76 |
| Water | 11.23 | 6.74 |
| Heat Treated Flour | 9.58 | 5.75 |
| Glycerine | 4.77 | 2.86 |
| Cellulose | 4.19 | 2.52 |
| Sodium tripolyphosphate | 3.07 | 1.84 |
| Sodium Caseinate | 2.19 | 1.31 |
| Propylene Glycol | 1.94 | 1.17 |
| Calcium Carbonate | 1.82 | 1.09 |
| Potassium Chloride | 1.53 | 0.92 |
| Vitamin Preblend | 1.34 | 0.80 |
| Salt, Iodized | 1.08 | 0.65 |
| Potassium Sorbate | 0.54 | 0.32 |
| Choline Chloride | 0.31 | 0.19 |
| Poultry Liver Digest Powder | 0.28 | 0.17 |
| Total | 100.00 | 60.00 |

Another example of a recipe of ingredients for a two component pet food product of the present invention is shown in Table. 6.

TABLE 6

| Ingredients for the outer component | % of total | % of component |
|---|---|---|
| Rice Flour | 15.2 | 38.0 |
| Water | 3.4 | 8.5 |
| Chix By-product meal w/BHA/BHT | 3.0 | 7.4 |
| Glycerine | 2.7 | 6.8 |
| Corn Whole #2 Yellow | 2.3 | 5.6 |
| Soy protein isolated obsolete | 2.0 | 5.1 |
| Flour heat treated | 1.9 | 4.7 |
| Wheat gluten | 1.5 | 3.8 |
| Corn gluten meal 60% | 1.5 | 3.8 |
| Vegetable oil | 1.3 | 3.3 |
| Propylene glycol | 0.9 | 2.4 |
| STPP | 0.9 | 2.1 |
| Calcium carbonate | 0.5 | 1.2 |
| CTMP | 0.5 | 1.2 |
| Potassium chloride | 0.4 | 1.0 |
| Vitamin premix - PMT with NBD | 0.4 | 1.0 |
| Sodium caseinate SS | 0.4 | 0.9 |
| Icing sugar | 0.3 | 0.8 |
| Salt iodized | 0.3 | 0.8 |
| Poultry liver digest powder | 0.2 | 0.5 |
| Potassium sorbate | 0.2 | 0.4 |
| Choline cholride | 0.1 | 0.2 |
| Meat solubles | 0.1 | 0.2 |
| Pet-Ox custom dry | 0 | 0.1 |
| Total | 40.00 | 100.00 |
| Ingredients for the inner component | % | % |
| Chix By-product meal w/BHA/BHT | 19.6 | 32.7 |
| Rice flour | 14.2 | 23.7 |
| Water moisture balance | 5.5 | 9.1 |
| Wheat flour - SS obsolete | 6.1 | 10.2 |
| Glycerine | 3.9 | 6.4 |
| Corn gluten meal 60% | 3.6 | 5.9 |
| Vegetable oil | 2.3 | 3.9 |
| Propylene Glycol | 1.5 | 2.6 |
| CTMP | 1.4 | 2.3 |
| Vitamin premix - PTM with NBD | 0.9 | 1.6 |
| Malted barley, ground | 0.8 | 1.4 |
| Potassium Sorbate | 0.1 | 0.2 |
| Pet-Ox custom dry | 0.1 | 0.1 |
| Total | 60.00 | 100.00 |

### Example 2

Another embodiment of the pet food of the present invention can be a one component product 30 in the shape of a boneless pork chop having a length in the range of 2.5 to 17.5 cm, a width in the range of 2.5 to 17.5 cm and a depth in the range of 0.42 to 5.0 cm (FIG. 5). The side surfaces 31 of the this embodiment can have ridges that give the appearance of meat and smooth edges surfaces 33. In a preferred embodiment, the moisture content can be 39.79 wt %, the protein content 11.57 wt %, the fat content 1.68 wt % and ash content 3.76 wt % and the fiber content 2.37 wt %. Table 7 lists the ingredients that can be utilized to form this embodiment.

TABLE 7

| Ingredients | % |
|---|---|
| Wheat Whole Grain | 50.51 |
| Water moisture balance | 34.00 |
| Tallow Beef | 4.54 |
| Gluten | 4.50 |
| Chicken Byproduct Meal | 3.00 |
| Vitamin Premix - | 1.85 |
| Pet Ox Plus Liquid | 1.00 |
| Salt, Non-Iodized | 0.50 |
| Potassium Sorbate Liquid | 0.10 |

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A pet food product comprising: N pieces wherein N pieces provide the complete and balanced daily nutritional requirements of an animal, and N equals 1 to less than 15 pieces, wherein each piece has a caloric content between 50 to 2500 kcal.

2. The pet food product of claim 1, wherein each of the N pieces has an inner component having a hardness value in the range of 50 to 2760 Max Force and an outer component having a hardness value in the range of 50 to 300 Max Force.

3. The pet food product of claim 1, wherein each of the N pieces has a brittleness value in the range of 430 to 1160 mm, a toughness value in the range of 0.5 to 5.5 Work and a hardness value in the range of 70 to 520 Max Force.

4. The pet food product of claim 1, wherein each of the N pieces has about 1.4 to 8.4 Kcal per gram and a caloric density of about 1.8 to 11.1 Kcal/cm³.

5. The pet food product of claim 1, wherein each piece is comprised of two components, an outer component and an inner component.

6. The pet food product of claim 5, wherein the inner and outer component have a different quality selected from the group consisting of hardness, brittleness, toughness, density, caloric density, calories per gram, color and flavor.

7. The pet food of claim 5, wherein the inner component comprises 10 to 95% of the product.

8. The pet food product of claim 1, wherein the product has a protein content in the range of 15 to 65 wt %, a carbohydrate content in the range of 30 to 70 wt %, a fat content in the range of 3 to 20 wt % and a fiber content in the range of 0 to 10 wt %.

9. The pet food product of claim 1, wherein the product has a water activity of less than 0.9.

10. The pet food product of claim 1, wherein the product is a single component.

11. The pet food product of claim 1, wherein the pet food product is configured such that the animal can hold the product with its appendages while eating the product.

12. The pet food product of claim 1, wherein the product has a longitudinal shape and a cross sectional shape in the form of a modified triangle having a length greater than 5 cm and a cross sectional area in the range of 3.0 to 18.0 cm².

13. The pet food product of claim 1, wherein the product has at least a ratio of 1:1 of product length to jaw width of the animal.

14. The pet food product of claim 1, wherein the product has a weight in the range of 20 to 400 grams.

15. The pet food product of claim 1, wherein N is 1 to 6.

16. The pet food product of claim 1, wherein an N piece has a consumption time of two to sixty minutes.

17. The pet food product of claim 1, wherein the pet food product is provided in a plurality of sizes comprising a small size having a weight range of 20-55 grams, a medium size having a weigh range of 55-100 grams, a large size having a weight of 100-250 grams, and an extra large size having a weight of 250-400 grams.

18. The pet food product of claim 17, wherein the small size product has a caloric content of about 135 kcal per piece, the medium product about 226 kcal per piece, the large product about 467 kcal per piece, and the extra large product about 783 kcal per piece.

19. A method of feeding an animal comprising the step of feeding an animal N pieces of a pet food product wherein N equals 1 to 15 in which N pieces provide the complete and balanced daily nutritional requirements of the animal and each pieces has a caloric content of 50 to 2500 kcals.

20. The method of claim 19, wherein N is dependent upon factors selected from a group consisting of an animal's weight, size, breed, lifestages, activity level, body condition, health status and total daily energy requirements.

21. The method of claim 19, wherein the pet food product is configured such that the animal can hold the product with its appendages while eating the product.

22. The method of claim 19, wherein feeding the pet food product provides an improved oral hygiene benefit to the animal because of the size, shape and texture of the product.

23. A feeding system for dogs comprising the steps of:
providing a pet food product in a plurality of sizes wherein each size of the product has a different caloric content;
feeding a dog N pieces of the pet food product selected from the plurality of sizes;
wherein N equals 1 to 15 in which N pieces provide the complete and balanced daily nutritional requirements of the dog and each piece has a caloric content of 50 to 2500 kcals.

24. The feeding system of claim 23, wherein N is dependent upon factors selected from a group consisting of an animal's weight, size, breed, lifestage, activity level, body condition, health condition and total daily energy requirements.

25. The feeding system of claim 23, wherein the plurality of sizes is selected from a group consisting of a small size having a weight range of 20-55 grams, a medium size having a weigh range of 55-100 grams, a large size having a weight of 100-250 grams, and an extra large size having a weight of 250-400 grams.

26. The feeding system of claim 25, wherein the small size product has a caloric content of 135 kcal per piece, the medium product 226 kcal per piece, the large product 467 kcal per piece, and the extra large product 783 kcal per piece.
